(19) United States
(12) Patent Application Publication
(10) Pub. No.: US 2025/0100601 A1
(43) Pub. Date: Mar. 27, 2025

(54) METHOD FOR HIGH-INTEGRITY LOCALIZATION OF VEHICLE ON TRACKS USING ON-BOARD SENSORS AND SCENE-BASED POSITION ALGORITHMS

(71) Applicant: Hitachi Rail GTS Canada Inc., Toronto (CA)

(72) Inventors: Veronica MARIN, Toronto (CA); Mohamed HELWA, Toronto (CA); Alon GREEN, Toronto (CA); David BEACH, Toronto (CA); Bojan SUBASIC, Toronto (CA); Walter KINIO, Toronto (CA)

(73) Assignee: Hitachi Rail GTS Canada Inc., Toronto (CA)

(21) Appl. No.: 18/892,088

(22) Filed: Sep. 20, 2024

Related U.S. Application Data
(60) Provisional application No. 63/584,272, filed on Sep. 21, 2023.

(51) Int. Cl. B61L 25/02; G01C 21/00; G06T 7/246; G06T 7/73; G06V 10/80; G06V 20/56

(52) U.S. Cl. CPC B61L 25/026; G01C 21/005; G06T 7/248; G06T 7/74; G06V 10/806; G06V 20/56; G06T 2207/10028; G06T 2207/30184; G06T 2207/30248

(57) ABSTRACT

A method of determining a position of a train (localization) includes initializing a train position with no a priori position information (e.g., at power up), i.e., cold localization, and determining a train position within a known coarse region, i.e., warm localization. On-board sensors are used to detect landmark objects in a localization region of the guideway, based on distinct features of the landmark objects. Detectors detect object features and the object features are fused. Landmark objects are tracked over time in a unified local reference frame such that a sliding window of landmark objects is maintained as a local map. Object features of landmark objects in the local map are compared to a reference map in order to uniquely identify a corresponding constellation of landmark objects in the reference map.

### PRIORITY CLAIM

The present application claims the priority of U.S. Provisional Application No. 63/584,272, filed Sep. 21, 2023, which is incorporated herein by reference in its entirety.

### BACKGROUND

A general method for position determination for a transportation vehicle may use a light detection and ranging or laser imaging, detection, and ranging sensor (LiDAR sensor) mounted on the vehicle. The method may include receiving a three-dimensional (3D) image captured from a vehicle on a pathway; transforming the 3D image into a first two-dimensional (2D) image; and determining a location of the vehicle along the pathway, including: comparing the first 2D image to a plurality of second 2D images each captured at a respective known location along the pathway, selecting one or more of the second 2D images based on the comparison, and determining the location of the vehicle along the pathway based on the known location where the selected one or more of the second 2D images was captured.

A general vehicle localization system may use a digital map and vehicle sensor data including information of the environment and/or ego movement of the vehicle. A method may adjust parameters and operation of modules to select specific sensor data/landmarks to be used in order to adapt or improve the degree of robustness of the localization. Based on measuring robustness for a ‘scenario’ derived at the current moment, allocating this robustness to the localization, filtering sensor data based on this robustness, and localizing using filtered sensor data and the map. Adjusted parameters based on allocated scenario may include number of objects (landmarks) considered, maximum landmark/usable sensor range, map resolution, matching parameters, algorithm used, and particle number in particle filters.

A general method for landmark-based localization of a vehicle may include forming a plurality of position hypotheses for a vehicle position based on associations between sensor landmark objects detected by sensor and map landmark objects stored in a digital map. A most likely vehicle position may be ascertained as the localization result on the basis of a probabilistic filtering of the position hypotheses, and a guaranteed position area may be ascertained, in which a predefined error upper limit is not exceeded. This may be performed several times with different set-ups of the probabilistic filtering. The localization result with the smallest guaranteed position area may be selected as vehicle position if the guaranteed position areas overlap fully in pairs.

A general method for landmark-based localization may include a process in which a plurality of position hypotheses are determined and processed to obtain position with suitable integrity and performance characteristics. By analyzing all position hypotheses and filtering out all false information using probabilistic analysis (e.g., histogram filtering and protection limit analysis), a position hypothesis with an integrity value may be determined, i.e., a measure of correctness of the landmark association between the sensor landmark object and the map landmark object on which the respective position hypothesis is based. A position hypothesis with a position accuracy sufficient in a predetermined way for determining the position of the vehicle may be determined by filtering hypotheses according to predetermined limit value.

A general method for semantic segmentation of sensor data may include the use of a machine learning model (e.g., a neural network); the model may accept input images representing sensor data of particular geographical areas, and such models may be used to build localization systems for individual sensors (camera, LiDAR, radar). Output of localization pipelines may then be combined together.

A general method for determining the position of a point in space may include using 3D point clouds of LiDAR data and/or 2D images of camera data. Landmark points may be defined, and ranges to the landmark points may be determined and then used to determine the position of the point of interest in space using the known positions of landmark points and a trilateration method.

A general method for determining the position of a vehicle may include comparing a sensed scene to stored experiences (set of scenes) captured at the same location. Possible variations in the scene (for example changing weather/lighting conditions) may be handled by storing more experiences in the database with which to compare.

A general method for localization and mapping using camera images may include identifying a landmark depicted in the image together with some parameters/features of the landmark using a landmark identification module. The parameters of the landmark may then be compared to known parameters of the landmark in a database, and then the known location of the landmark may be used to update the position of the vehicle.

A general method for estimating the position of a mobile device in a 3D environment, e.g., hand-held devices, robots, or vehicles, may use stereo cameras and an inertial measurement unit (IMU), and may use matching visual features of landmarks for identifying landmarks and then using their known locations to determine the vehicle pose.

A general method for determining the position of a vehicle may use LiDAR and/or radar and a predefined map of landmark points. The predefined map may further include a spatial assignment of a plurality of parts of the map environment to the plurality of elements. The method may determine at least one scan comprising a plurality of detection points, match the plurality of detection points with the plurality of elements of the map, and determine accordingly the position of the vehicle based on the matching.

The need for dense installation of landmark objects is a drawback of localization techniques based on transponders or ultra-wideband (UWB) technologies. In particular, those technologies may use dense installation of passive landmarks either on the tracks (e.g., radio-frequency identification (RFID) transponder tags), or dense installation of active landmarks (e.g., UWB anchors) in designated areas such as platforms, switches, or signals. These landmarks require installation effort and maintenance effort which may influence revenue operation due to the need to close track section or sections for the landmark installation and maintenance. Active landmarks may be disliked by users because they may require additional maintenance and installation effort such as providing power to the landmarks.

A lack of integrity or a lack of a high integrity design of a localization system is a detriment in safety-critical rail applications. Some methods may attempt to provide integrity using a probabilistic framework, namely a protection limit argument of position hypotheses. However, this probabilistic framework may not be suitable for addressing systematic errors (e.g., non-modelled sensor bias, train motion model limitations) or addressing limitations of sensor technologies (e.g., scene and environmental effects), which may be difficult to model probabilistically. Also, the protection limit arguments may suffer from having non-justifiable assumptions on error distributions (e.g., Gaussian error) and non-justifiable selection of some parameters (e.g., a priori fault probability). Such methods may not provide a safe architecture utilizing multi-sensor diversity, algorithmic diversity, safety supervisions or interpretable features for matching, which are all important characteristics of high-integrity systems for Safety Integrity Level 4 (SIL4) certification. For at least these reasons, the certification of these probabilistic filters in the rail domain is challenging. Another example of a disfavored design choice for high-integrity applications is the use of single-sensor technology for landmark detection (no diversity).

A lack of the use of interpretable matching features may make it difficult to justify the use of matching methods in a safety-critical application. For example, a method that compares entire images using automated feature extraction and computer vision algorithms may not allow for easy explanation, in a way understandable by human, of what object features are used in the matching decision and hence in localization. A similar concern applies to comparing a detected scene to previously stored images of experiences. General methods may not explicitly consider rail vehicle applications.

General methods may not provide for verifying robust uniqueness of a constellation of landmarks, i.e., verifying uniqueness of a constellation of landmarks under various perturbations (e.g., sensor measurement errors, false detections, misdetections, and occlusion), even in the case of verifying uniqueness of natural landmark objects in the scene under ideal conditions, nor has it been shown how to determine a number and location of additional for-purpose landmark objects to satisfy robust uniqueness conditions and hence high-integrity localization. General methods may not address uniqueness of a constellations of landmarks under perturbations or integrity. A general method may assess the effect of adding landmarks in a geographical region on position accuracy in addressing localization in the region, but without considering robust uniqueness of a constellation of landmarks or how to verify this property to determine for-purpose landmarks for achieving high-integrity localization.

General methods may lack temporal tracking of scene features, and thus may not provide robustness against false detections and for handling a case where the distinct scene features for localization are extended geographically over a distance longer than the sensor field of view (FOV).

General methods that store entire images/experiences in a database may be strongly tied to the conditions under which those images are captured, and hence, may not be robust to changes in scene or environmental conditions (e.g., weather or lighting conditions). A method that stores various images of all previous experiences may not be enough to capture all possible variations of a scene and environment conditions, which may be non-feasible. Also, a method that uses one sensor technology may be non-robust due to limitations of the sensor technology.

A general method may save entire images captured at each location instead of modular information of landmark objects, but a simple update to one of the landmark objects (e.g., location of a sign) would require re-capturing the entire images of the corresponding region in the database, which is a lengthy and expensive process and presents difficulty of maintaining/updating the database.

Other approaches compare entire images with the aid of automatic feature extraction and computer vision algorithms.

Other approaches re-capture an entire image at a location when an update is made.

Other approaches that compare entire images are computationally expensive.

Other approaches do not use a method for verification of robust uniqueness of a constellation of landmark objects.

Other approaches do not provide a high-integrity location localization system.

Other approaches do not provide integrity and are not designed for high integrity, or limit integrity analysis to a probabilistic protection limit argument, which typically suffers from non-justifiable assumptions and cannot handle/model scene/environmental limitations.

Other approaches do not use relevant natural landmark objects and features for rail.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system architecture of a multi-sensor scene-based localization system for achieving high integrity via sensor diversity, algorithmic diversity and proper sensor diagnostics and function safety supervisions, according to one or more embodiments.

FIG. 2 is a schematic diagram of an example of database schema of map information of sample natural landmark objects and contextual information connecting the landmark objects to the guideway spline/track, according to one or more embodiments.

FIG. 3 is a schematic chart of offline verification methods of robust uniqueness of a constellation of landmark objects, according to one or more embodiments.

FIG. 4 is a schematic illustration of a sign and guideway direction information, according to one or more embodiments.

FIG. 5A-5B are schematic illustrations of position estimation using a sign, according to one or more embodiments.

FIG. 6 is a schematic illustration of position estimation, according to one or more embodiments.

FIG. 7 is a schematic illustration of position estimation in which estimated positions are inconsistent, according to one or more embodiments.

FIGS. 8A and 8B are schematic illustrations of a natural landmarks constellation, in which FIG. 8A is a top view and FIG. 8B is a front view, according to one or more embodiments.

FIG. 9 is a block diagram of a processing system according to one or more embodiments.

### DETAILED DESCRIPTION

This disclosure describes embodiments and examples of the subject matter set forth herein and, although specific examples of components, materials, values, steps, arrangements, or the like may be described, such examples are not limiting and other components, materials, values, steps, arrangements, or the like are contemplated.

As used herein, a term preceded by “a” or “an” (and “the” when antecedent basis is “a” or “an”) indicates both singular and plural of such term, unless indicated otherwise.

Further, like numbers are intended to denote like elements throughout this disclosure and the drawings, but like numbers or other referential descriptors do not imply a specific hierarchy or order. Likewise, references to “first,” “second,” “third,” or the like do not imply a specific order.

Further, a description of a first element being “on” a second element may include a case in which the first element is directly on the second element, i.e., the first and second elements are in direct contact, and may also include a case in which an additional element is between the first and second elements, e.g., a case in which the first and second elements are not in direct contact.

Further, the terms “comprises,” “comprising,” “includes,” “including,” “has,” “having,” and variations thereof indicate a non-exclusive inclusion. For example, a process, article, or apparatus that “comprises” a list or set of stated elements is not limited to only the stated elements, and may include other elements not expressly listed or stated.

Further, the term “or” is inclusive, not exclusive, such that the term “or” means “and/or” unless indicated otherwise. Thus, “A or B” means “A and/or B” and encompasses A alone, B alone, and both A and B, unless indicated otherwise.

Further, spatially relative terms, such as “beneath,” “below,” “lower,” “above,” “upper” and the like, may be used herein for ease of description to describe one element or feature's relationship to another element(s) or feature(s) as illustrated in the figures but do not imply a fixed orientation. The spatially relative terms are intended to encompass different orientations in addition to the orientation depicted in the figures.

One or more embodiments is directed to providing robustness in assessing a scenario of an environment (e.g., vehicle speed, road type, road speed) and expected degree of robustness of localization for the determined scenario, and then adapting/controlling one or more parameters of the scenario (e.g., sensor detection ranges, number of landmark objects used for localization) to end up in an ascertained localization scenario.

One or more embodiments use natural landmarks and a constellation of natural landmarks for position.

One or more embodiments use for-purpose landmarks and a constellation of natural landmarks for position.

One or more embodiments use a common sign or reflective surface detectable by camera, LiDAR, and/or radar.

One or more embodiments are directed to avoiding reliance on probabilistic approaches (i.e., avoiding argument based on protection limit algorithms).

In one or more embodiments, an example of a specific landmark object for rail environment is a platform edge, and an example of a contextual feature for a rail environment is the association between the landmark objects and the train track/path.

One or more embodiments are directed to the technical domain of Communication Based Train Control (CBTC), particularly autonomous trains. One or more embodiments provides a method to determine the train position (localization) with high integrity using multiple on-board sensors (e.g., cameras, LiDARs, radars, inertial measurement units (IMUs), or the like), minimal trackside infrastructure, and a certifiable map. This includes initializing the train position with no a priori position information (e.g., at power up and denoted herein as a “cold localization problem”) and determining an accurate train position within a known coarse region (denoted herein as a “warm localization problem”). Accurate localization of a train using the disclosed method is not necessarily performed continuously, but at distinct regions of interest of the guideway where more accurate position is desired (for example, at platforms or near level crossing and switches) (these regions are denoted as “localization regions”). Positioning in-between localization regions is determined using dead reckoning algorithms, in at least one embodiment.

In at least some embodiments, a map is certified through a number of steps. A survey is performed collecting data using high resolution LiDAR, radar, camera and/or IMU systems to determine track centerline. In at least some embodiments, additional survey data for use during revenue operation is collected. The collected survey data is processed to identify the track centerline and landmark features. An assessment is performed to determine if the landmarks are uniquely identifiable. If the landmarks are not uniquely identifiable, for-purpose landmarks are added to ensure uniqueness. A database is created which includes the track centerline and the landmarks (existing and for-purpose added landmarks). Correspondence tests are performed in the field to verify that landmarks are correctly identified at expected locations.

Accurate positioning at localization regions (up to centimetres level) is important for running services such as platform alignment, obstacle detection, and signal aspect recognition. For example, accurate train position is typically important in determining an accurate motion authority region ahead of the train for obstacle monitoring especially in curved track regions or near switches, or in distinguishing which of the signals ahead is the signal associated to the track of the train under consideration in multi-track segments of the guideway.

Train position (localization) is typically determined by a transponder interrogator installed on-board the train and transponder tags installed on the track. Other solutions, such as UWB tags and anchors, are common in general systems. These solutions require installation of RFID transponder interrogator or tags or UWB anchors on wayside in localization regions. In some cases (e.g., UWB anchor) the installed wayside object is active (i.e., uses plug-in or battery power).
1. Such approaches thus use dense installation of on-track or wayside objects within the localization regions for transponder tags and UWB anchors, respectively. This, in turn, leads to increased cost of solution and its maintenance.
2. Also, on-track equipment, e.g., transponder tags, are difficult/expensive to maintain.
3. In some solutions (such as UWB), the installed infrastructure objects are active, which requires securing power and hence having more regular maintenance.
4. Also, localization accuracy may not meet the accuracy requirements for platform alignment (typically 10 cm). For example, transponders have a typical footprint of 1 to 2 meters.

Localization may also be performed using Global Navigation Satellite System (GNSS). However, localization accuracy is typically worse than the desired accuracy level of a few centimeters, and GNSS is not always available underground (e.g., in tunnels).

One approach to localize a train compares a scene perceived by an on-board vision sensor (e.g., LiDAR or camera) to stored scene information contained in a database constructed offline. For example, a method may receive a 3D image captured by LiDAR installed on a vehicle on a pathway, transform the 3D image into a 2D image, and determine a location of the vehicle along the pathway by comparing the 2D image to a plurality of 2D images each captured at a respective known location along the pathway using classical computer vision techniques. This approach compares raw, simple features extracted using automated feature extraction applied to raw sensor data (feature matching). Another approach is to use higher-level object matching, where complex objects with high-level characteristics are detected and matched based on the collection of characteristics. Other approaches may use a single vision sensor, or a variety of vision sensors.
1. Lack of focus on integrity of the position measurement: This may include lack of consideration of safety supervisions or the incorporation of trustable information (e.g., SIL4) in the monitoring or verification of the processing. This may also include the lack of diversity of sensors or processing in the approach; for example, many solutions rely on one sensor technology and hence they are prone to limitations/errors of the selected sensor technology. In some cases, general approaches focus on the performance (e.g., accuracy) of the localization rather than the integrity (trustworthiness). In some cases, the use of probabilistic filtering can introduce significant challenges for provable integrity/safety certification.
2. Lack of interpretable matching features, particularly when using feature matching approaches: Some approaches rely on matching features between reference data and current onboard sensor data (i.e., feature matching), and in some cases these features are extracted using automated feature extraction algorithms (e.g., SIFT, SURF in 2D). Comparing images using automated feature extraction and computer vision algorithms lacks interpretable definition of features for comparison, and hence, the found localization solution is difficult to interpret or justify. The resulting reference database/maps are also much more difficult to validate.
3. Lack of temporal tracking of scene information: Rail guideway environments (in particular, underground tunnel sections) typically have repeatable patterns of some objects (e.g., pillars), and one instance of captured data by on-board sensor may not be enough to identify unique location on the guideway. These situations may be handled by fusion/amalgamation of sensor data over a temporal window, the construction of a temporally- and/or spatially-local map, or the ability of the system to ‘dead-reckon’ (operate with landmarks) for an extended period of time. As well, the vehicle may need to travel for some distance beyond the field of view of the used sensor technology to collect enough scene features to uniquely identify the scene and hence the location of the vehicle within the guideway. In many general solutions, these approaches are not described.
4. Non-robustness against sensor variation, scene changes and various environmental conditions: Stored data for particular scene conditions may not be suitable for comparison with data captured online in a different scene condition. For example, a neighbor train may occlude a considerable portion of the infrastructure objects in the scene leading to poor matching, or objects may be perceived differently from the onboard sensor in poor weather or lighting conditions as compared to ideal weather and lighting conditions. Storing database images for all the possible scene scenarios may not be feasible. In cases where feature matching of raw data is used, and where the reference map is built from raw data from a different sensor that may be in a different location on the vehicle, a transformation must be applied to transform the current sensor data to the reference data, or vice versa, and this transformation can be error-prone and difficult to validate.
5. Lack of verification method for uniqueness of scene: The general techniques do not provide a method to verify that scene images stored in the database are dissimilar enough to uniquely identify the position on the guideway. The risk is that (even small) detection errors of onboard sensor may lead to wrong matching to a similar image in a different region of the guideway resulting in a wrong vehicle position and consecutive safety hazards.
6. Difficulty of maintaining/updating the database: Since the database contains images and not modular information of objects, any minor change to even one feature of one object in the scene (e.g., location of a sign) may require full update of the localization region images in the database. This process is lengthy and expensive.
7. Computationally expensive methods: Comparing raw data (e.g., in feature matching approaches) is more computationally expensive than comparing individual characteristics of selected objects, and may not be feasible to run in real time. While one can argue the possibility of using large number of parallel processors, this leads to increased cost of the solution.

One or more embodiments provide a multi-sensor-based localization system that uses diverse on-board sensor technologies (at least a 3D sensor such as LiDAR/imaging radar and a 2D sensor such as camera) and a certifiable reference map for achieving high integrity.

One or more embodiments uses diverse on-board sensors to detect objects in the localization region of the guideway, based on distinct features of the objects. The objects are denoted herein as landmark objects, and they can be individual objects or constellation of landmark objects with distinctive features. Landmark objects can be either (1) general objects in guideway such as signals, signs, electrical boxes, lighting or lampposts, platforms, buildings within the guideway, switches, switch actuators/switch machines, gantries and mounting appendages, and similar wayside infrastructure, denoted herein as natural landmarks, and also (2) installed objects for the purpose of localization such as passive radar reflectors, denoted herein as for-purpose landmarks. It is also possible to design the for-purpose landmark object to be a detectable sign by diverse sensor technologies for redundant detections and improved integrity. In at least some embodiments, landmark objects comprise one or more permanent features including one or more of a tunnel mouth, a change in tunnel structure, a tunnel bifurcation, a platform, a building, a sign, a lamp, an electrical box, or a signal. One or more embodiments use natural landmark objects, for-purpose landmark objects, or a mix of the two types, resulting in an augmented constellation of landmark objects. The augmented constellation is beneficial for the case when the guideway objects are similar between consecutive regions and for-purpose landmarks (e.g., passive reflectors or multi-sensor detectable sign) are added to bring uniqueness to the identification of each region constellation.

Examples of the object features/characteristics that are detectable by the 3D sensor include but not limited to shape features (size, height, width, length of objects), relative distances between different landmark objects in the constellation (constellation pattern/spatial distribution), and reflectivity/intensity features of objects. Examples of additional features detectable by the 2D sensor, such as camera, include but not limited to object color and textual information. In addition to the aforementioned features, one or more embodiments also utilize contextual scene features to increase robustness and ensure that the whole set of features can result in a unique identifier of the constellation of the landmark objects globally over the guideway for the case of cold localization problem or locally over the coarse position region for the case of warm localization problem. Examples of contextual scene information include but not limited to relative location of the landmark objects with respect to the train path, denoted herein as the ego track. One or more embodiments identify the landmark objects that are associated/close to the ego track, whether the objects are on left/right of the track and their expected order of appearance for a particular orientation of the train, and perpendicular/lateral distance of the object to the ego track. This information is especially useful for solving ambiguity of track path in multi-track segment. Also, landmark objects associated to the ego track are less likely to be occluded (for example by neighbor trains) and hence they are more robust against scene changes.

One or more embodiments then fuses the object features from the diverse sensor technologies, and tracks them over time in a unified local reference frame—the result is a sliding window time, from a definable time in the past and up to and including the present moment, such that a sliding window of landmark objects is maintained, called a local map. Fusion of features from diverse sensor technologies is important for better handling of potential false detections of individual sensor technologies resulting from their sensing limitations or from the detectors. Temporal tracking is important for reducing false detections, to handle large objects beyond FOV of sensors that need to be detected over multiple frames (e.g., platforms, long buildings), and to store scene information over enough distance to collectively form unique scene features. Temporal tracking is a time-dependent tracking method using tracking of objects from a previous time stamp to track objects in the current time stamp. As previously mentioned, one frame/image of the scene may not have enough unique features to localize the train with no ambiguity with other similar scene images captured in other locations.

Next, one or more embodiments compare the features of the constellation of objects in the local map, including the contextual scene features, to the reference map in order to uniquely identify the corresponding constellation of landmark objects in the reference map. The locations of the landmark objects are known in global coordinates in the reference map. Hence, one or more embodiments uses the known locations of the landmark objects in the global coordinates and sensor measurements (e.g., measured ranges to the landmark objects) to identify position of a reference point of the train under consideration in the global coordinates of the reference map. In one or more embodiments, a transformation matrix (i.e., rotation matrix and translation vector) is defined between local and global map coordinates based on locations of corresponding landmark objects in both maps, and then the transformation matrix is used to transform the location of the reference point of train under consideration from local to global coordinate frame.

Natural landmarks may be used to calculate location of a vehicle. One or more embodiments includes various consistency checks and supervisions to increase robustness and to properly handle false detections, with the aim of building characterizable and quantifiable integrity or trust into the localization measurement. Examples include a) supervisions on machine learning detectors (e.g., commercial-off-the-shelf (COTS) detectors or in-house detectors) using classical detection algorithms, b) supervision on motion pattern of detected objects in the local map over a time window to verify that they follow the same motion pattern (e.g., speed) as the train under consideration, and hence, build confidence that the objects are in fact stationary objects. In one or more embodiments, a filter is added to remove objects with non-trusted motion patterns which is important for filtering out potential moving objects in the scene including moving neighbor trains and pedestrians, c) supervision on maximum permissible root mean square error (RMSE) between the distances from determined position to location of landmark objects in the reference map on one hand and the measured ranges to the corresponding objects in the local map on the other hand.

One or more embodiments also provide a method for evaluating the robust uniqueness of a constellation of landmark objects in the reference map, and a methodology to enforce robust uniqueness by adding for-purpose landmarks to locations where constellations are not unique. The robust uniqueness term is hereby used to indicate uniqueness under various perturbations including sensor measurement errors (of ranges and/or object features), false positive/negative detections and possible occlusions. The evaluation method facilitates assessing the uniqueness of the constellation of natural landmark objects in the guideway, so that it is properly decided where for-purpose landmark objects are desired for improved robust uniqueness of a constellation of landmarks. This provides the proper balance between the robust performance achieved by using for-purpose landmarks designed for localization and the cost of added infrastructure objects.

### Advantages

1. In comparison to general CBTC localization technology, one or more embodiments use general guideway objects (natural landmarks) whenever possible, which reduces the cost of installation and maintenance of on-track/wayside objects compared to transponder tags and UWB solutions, respectively,
2. One or more embodiments provide high-integrity position based on using diverse multi-sensor technologies, using diverse algorithms (e.g., classical detection supervisions of machine learning based detectors) and proper supervisions. This is an advantage over general scene-based positioning methods that typically rely on one sensor technology and are not designed to achieve high integrity.
3. In comparison with general feature matching approaches (e.g., using comparison of capture images and automated feature extraction), one or more embodiments incorporate higher-level object matching and utilize interpretable features of the landmark objects and the scene that are easily understood and justified by humans. This advantage, together with the previous one, makes one or more embodiments more suitable to be used for safety-critical rail applications.
4. One or more embodiments utilize temporal tracking, which reduces the impact of false sensor detections of objects, and enables the method to handle situations where the distinct scene features are extended over a distance longer than the field of view of the sensors.
5. One or more embodiments incorporate the contextual scene features such as defining associated objects to the ego track to increase robustness of the solution, for example against possible occlusion of landmark objects by neighbor trains.
6. One or more embodiments provide a systematic approach for evaluating robust uniqueness of a constellation of landmark objects, which informs the decision of where for-purpose landmark objects are desired. Existing scene-based positioning methods do not provide a systematic methodology for evaluating uniqueness of a constellation of landmark objects.
7. Modularity of the landmark objects in the constellation in one or more embodiments simplifies the process of map update for the case where few changes are happening to constellation objects features (e.g., position update of one sign). On the other hand, general methods based on comparison of images would require re-capturing full images of updated localization region even if the change happened to a single object feature.
8. One or more embodiments is computationally efficient as it only compares properly selected features of finite objects and not entire images or large image feature sets.

One or more embodiments include determining with high integrity the orientation of the train on the guideway as well, i.e., the guideway direction in which the sensor's FOV is facing. This is an advantage over other scene-based positioning methods that do not provide orientation.

### Acronyms

AoA: Angle of Arrival
CBTC: Communication Based Train Control
FOV: Field of View
GD: Guideway Direction
GTS: Ground Transportation Solutions
LiDAR: Light Detection and Ranging
QR: Quick Response
Radar: Radio Detection and Ranging
RF: Radio Frequency
RFID: Radio Frequency Identification
SSD: Seven Segments Display
TAP: Thales Autonomy Platform
UWB: Ultra Wide Band

### Definitions

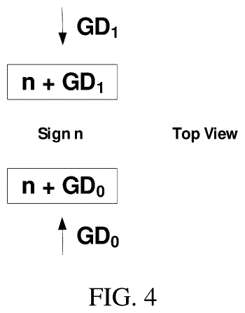

Localization: a function that determines the localization reference point position on the guideway, the train orientation on the guideway (i.e., facing towards GD₀ or GD₁)) and the associated travel direction (i.e., moving in GD₀ or GD₁), with a specified accuracy ensuring discrimination between different tracks. FIG. 4 is a graphical depiction of a top view of the orientation and travel direction determinable with respect to a given sign n. The function may not have continuous coverage in the sense it is expected to operate within discrete zones on the map. In between these zones, the position is determined by a dead reckoning position estimate.

Reference point: a point on the train, typically associated with one sensor location on the train, which its position on the map is determined by the localization function.

Unique localization: localization with no ambiguity in terms of discrimination between tracks. Typically, unique localization is required upon cold start and every certain time and/or distance travelled (e.g., every platform) and upon point traversal (e.g., switch position or connected path are known). The ambiguity while traversing a switch can be addressed by (a) using the switch position provided by the Zone Controller, or (b) using branch discrimination function that solely relied on the measurements of on-board sensors.

Warm localization: along tracks localization for position correction when the previous position is known (uniquely localized) with no risk of track ambiguity. The position uncertainty is reduced when the landmark or landmarks are accepted and the position is corrected. Typically, warm localization is sufficient after cold start when the train is moving on single tracks (i.e., no point is traversed).

Natural landmark: a landmark that is not installed for localization purpose that either has distinctive features in terms of reflectivity and shape or a constellation of several such landmarks have distinctive features in terms of reflectivity, relative geometry, and shape. It may or may not have globally unique identifier.

For-purpose landmark: a landmark that is installed for localization purpose that typically has distinctive identification (e.g., RFID transponder tag). It may not have a globally unique identifier (e.g., reflective surface in the radar or LiDAR frequency spectrum).

Landmarks constellation: a group of landmarks with certain distinct features such as reflectivity, relative geometry and/or shape (landmarks metadata)

Landmark identification: unique identification of the landmark location on the map.

Passive Landmark: A landmark that does not require power for its operation.

Orientation: The guideway direction the sensor's FOV is facing.

Reference map: A certifiable high-density map, constructed offline typically using high resolution survey sensors, which contains landmark objects and guideway spline information (features and locations in global coordinates frame).

Local map: A map of trustable detected objects and train path (spline), constructed online from sensor data, and is represented in a unified local coordinate frame. Constellation of objects in the local map are compared to stored constellations in the reference map for uniquely identifying the local map objects, and hence, determining their location in the global coordinate frame.

Feature matching: Comparison of scene features extracted by automatic feature extraction algorithms from raw sensor data vs features stored in database.

Object matching: High-level characteristics of objects are detected and compared against stored characteristics of those objects in the reference map.

SIL4 Odometry: Existing function that provides speed measurement and travel direction determination, with a guaranteed PFH (probability of dangerous failure per hour) of 1e-9/h or greater. The function does not require the use of tachometers or wheel sensors, and does not rely on vehicle position or map knowledge.

SIL4 Stationary Status: Existing function that provides indication that vehicle is stationary or non-stationary (binary output), with guaranteed PFH of 1e-9/h or greater. The function does not require the use of tachometers or wheel sensors, and does not rely on vehicle position or map knowledge.

The technical and exploitation domain of one or more embodiments is vehicle localization (on a map), in particular rail vehicle in CBTC system or autonomous train. The localization function provides both position and orientation of the vehicle, and is expected to achieve Safety Integrity Level (SIL) 4 properties and meet the performance (accuracy) requirements for rail vehicle.

One or more embodiments provides a method to localize a rail vehicle on the map relying on natural landmarks constellations on the guideway and its surroundings complemented by installed for-purpose landmarks (e.g., signs) with non-dense installation.

One or more embodiments provide a method in which guideway objects (e.g., signs, signals, poles, electric boxes) of platform, switch, and signals areas are used by the method. In one or more embodiments, such guideway objects are substituted by or complemented by more fit for-purpose signs, installed in the same locations, such as signs that are printed with ink or other material that is reflective in the radar and LiDAR frequency spectrum, or signs with a 3D shape that is detectable by the LiDAR.

SIL4 integrity properties of the function is achieved by multiple independent and diverse sensors using dissimilar and orthogonal sensing technologies and diverse algorithms, as well as using temporal diversity satisfied through tracking of landmark objects over time and function supervisions for detection and removal of moving objects in the scene and removal of false sensor detections.

Accuracy is improved because fusion of multiple sensors measurements in the position estimate yields better accuracy than the more accurate sensor.

The technical problem is to provide a high-integrity localization function that achieves high accuracy but also minimizes the use of on-track/wayside installed objects for cost reduction.

On one hand, typical localization methods, such as transponder tags or UWBs, depend on relatively dense installation of on-track or wayside objects, respectively. In some cases, the installed wayside objects are active, i.e., use power (e.g., UWB anchors). Such solutions are expensive and difficult to maintain.

On the other hand, general scene-based positioning functions lack high-integrity properties which are important for safety-critical rail applications. They also usually lack the use of interpretable features for identification of landmarks used in the localization which is important for having explainable solution needed for safety purposes. Additionally, many of those methods lack temporal tracking of scene features which is important for robustness against false detections and for handling the cases where distinct scene features are not all contained within the sensors FOV at a single time frame. Moreover, the general approaches lack a verification method of uniqueness of the scene features which is essential for high-integrity evidence and for informed decisions of where for-purpose landmarks are needed. Furthermore, general methods are also non-robust against scene changes and environmental conditions, they are not computationally efficient, and they require significant efforts for database/map update for any small change in one of the scene objects as previously described in Section 1.

One or more embodiments use natural landmarks constellations and a minimal number of installed for-purpose landmarks. One or more embodiments provide a high-integrity localization function addressing issues in a general scene-based positioning function.

One or more embodiments provide a multi-sensor, scene-based localization system satisfying high integrity, which uses diverse on-board sensor technologies (at least one 3D sensor such as LiDAR, imaging radar, stereo camera and/or at least one 2D sensor such as monocular camera system) for uniquely identifying landmark objects and a certifiable reference map containing interpretable features of objects in multi-sensor spectra. Landmark objects are mainly natural landmarks that exist in the guideway (e.g., signals, signs, electric boxes, side lamps, platforms, buildings within the guideway), but can also be for-purpose landmarks installed for localization, or a mix of the two types resulting in an augmented solution.

One or more embodiments provide a method for verifying robust uniqueness of a constellation of landmark objects, i.e., verifying it is distinguishable from all other constellations in the position search region under various possible perturbations (e.g., sensor measurement errors, potential false detections, and partial/total occlusion of landmarks part of the constellation).

One or more embodiments provide a method, based on the above, for determining optimal number and location of needed for-purpose landmarks for achieving robust uniqueness of a constellations of landmark objects for high integrity in guideway regions with similar infrastructure.

One or more embodiments use landmarks with interpretable features in multi-sensor spectra and characteristics suitable for rail application.

One or more embodiments provide a method for incorporating contextual scene, environment and/or operational features, suitable for rail application, in determining the matching score of the constellation of landmarks.

One or more embodiments provide a method for handling large landmark objects beyond the FOV of the sensors (e.g., platforms, long buildings) using temporal tracking of the object features.

### High-Integrity Scene-Based Localization System

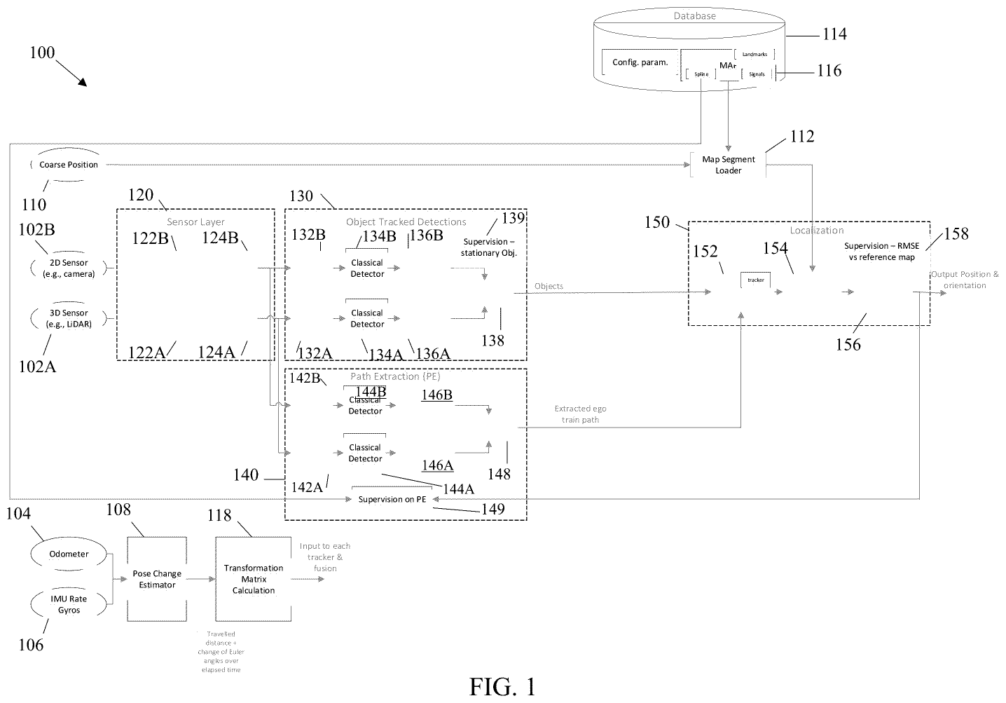

One or more embodiments has an architecture of a scene-based localization system 100 as illustrated in FIG. 1, including the following:

a. Sensors: One or more embodiments use at least two diverse sensor technologies for detection of landmark objects. Typically, and without loss of generality, the two sensors are a 3D sensor 102A such as LiDAR, imaging radar, stereo cameras and a 2D vision sensor 102B such as a camera. Sensors 102A and 102B are referred to herein as sensors 102.

In one or more embodiments, input speed information from a trusted SIL4 odometry function, e.g., odometer 104, and IMU rate gyros 106 is used to estimate (using pose change estimator function 108) the change of the pose of the train under consideration, denoted as the ego train, and this information is then utilized to improve the accuracy of the prediction step in tracking the objects in the trackers and fusion components of the architecture allowing for extended tracking distances and hence improved capability of building accurate, local map of distinct scene features.

In one or more embodiments, an input coarse position 110 is provided as shown in FIG. 1 to select a restricted position search region (map segment obtained by map segment loader functionality 112 from database 114). In some examples, the input coarse position source is GNSS, radio-based positioning system, or a trusted SIL4 dead-reckoning-based positioning system. The input coarse position will convert the cold localization problem, in which the position is not a priori known, to a warm localization problem in which a coarse position search region is known, In case of non-availability of coarse position input, the features of the landmark objects used in cold localization should be verified to be robustly unique over the entire guideway.

b. Certifiable Map: In one or more embodiments, a map 116 stored in database 114 (and the map segment loaded by map segment loader 112) contains guideway spline/track information and interpretable features of landmark objects detectable in multi-sensor spectra. In one or more embodiments, the landmark objects are general guideway objects (natural landmarks) such as signals, signs, electric boxes, side lamps, platforms, buildings within the guideway, but can also include for-purpose landmark objects (e.g., added signs, reflectors) to improve the robust uniqueness of a constellation of landmarks.

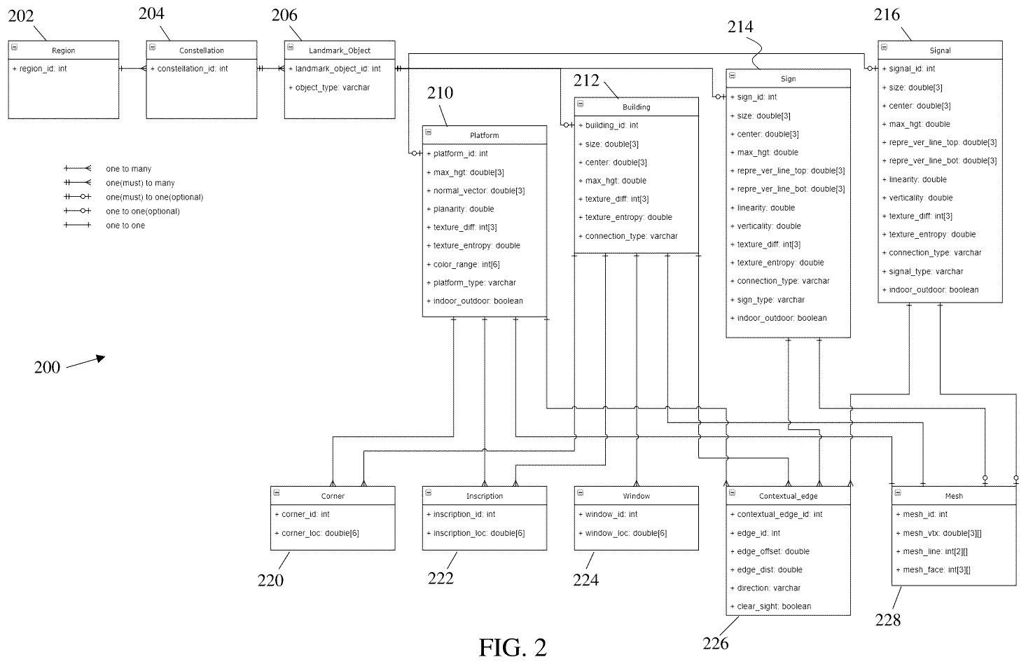

FIG. 2 provides an example of a map database schema 200 containing information of interpretable features of natural landmark objects and contextual features relevant to the guideway environment. A particular region 202 has a one to many relationship with one or more constellations 204 according to the schema 200. In an embodiment, there may be more than one regions 202 in the schema 200. Each constellation 204 has a one to many relationship with a landmark object in which there must be at least one landmark object related to the constellation 204. The database schema 200 also includes data structures for objects making up a constellation such as platforms 210, buildings 212, signs 214, and signals 216. Examples of the object features include shape features (size, height, width, length of objects), relative distances between different landmark objects in the constellation (constellation pattern), reflectivity/intensity features of objects, color(s) of object, textual information. Each landmark object has a one to one relationship with an object (i.e., objects 210-216) in which there must be at least one object for each landmark object 206. Additional elements in the database schema related to features of the objects 210-216 include corners 220, inscriptions 222, windows 224, contextual edges 226, and mesh 228. In at least some embodiments, mesh 228 is optional. Mesh 228 is a standard representation of point clouds through the use of a sparse set of points. The features 220-228 have a one to many relationship with the objects 210-216. Texture entropy is an indication of an amount of information/color in an image. In at least some embodiments, human can sense differences in texture entropy, e.g., colorful detailed images have higher texture entropy than black and white images.

One or more embodiments also utilizes contextual scene features to increase robustness and ensure that the whole set of features can result in a unique identifier of the constellation of the landmark objects 204. Examples of contextual scene information include but are not limited to connection type (object connected to track ground or to platform ground), relative location of the landmark objects with respect to the train path, denoted as the ego track. The map database stores for landmark objects when applicable the ID of the track they are associated to, whether the objects are on left/right of the track and their expected order of appearance for a particular orientation of the train, and perpendicular/lateral distance of the object to the adjacent track(s). This information is especially useful for solving ambiguity of track path in multi-track segments. Also, landmark objects associated to the ego track are less likely to be occluded (for example by neighbor trains) and hence they are more robust against scene variations and occlusion.

Returning to scene-based localization system 100, the system also includes a sensor layer 120 comprising functionality for processing input from 3D sensor 102A and 2D sensor 102B. The processing includes a parser 122A and 122B (collectively referred to as parsers 122) which receive sensor 102 output and generates output for processing to a diagnostics functionality 124A and 124B.

Parsers 122 receive output from sensors 102 (sensors 102A and/or sensor 102B) and convert the data to a structured format, e.g., data array, for handling by subsequent functionality in the processing chain. For example, parser 122A receives 2D sensor data from sensor 102B and converts it into a format for use by diagnostics functionality 124B.

c. Sensor diagnostics: Sensor diagnostics are performed to detect and flag malfunction behaviors of the sensors for improved integrity. In at least some embodiments, sensor diagnostics include determination of sensor over-temperature conditions or excessive sensor dropouts based on the sensor data provided.

Scene-based localization system 100 also includes an object tracked detections functionality 130. The object tracked detections functionality 130 includes AI-based detectors 132A and 132B (collectively referred to as AI-based detectors 132), classical detectors 134A and 134B (collectively referred to as classical detectors 134), trackers 136A and 136B (collectively referred to as trackers 136), and sensor fusion functionality 138. Tracker functionality 136 outputs tracked objects in the sensor space (e.g., camera 2D space or LiDAR 3D space) for input to fusion to fuse the data from different sensors. Functionality 130 also includes a supervision-stationary object functionality 139 configured to reject potential moving objects, e.g., moving trains or moving pedestrians, from object detection for localization purposes. In operation, the functionality 139 monitors an innovation difference in the filter of the fusion functionality 138, i.e., the difference between the predicted object position based on the ego train motion model and the measured position. If the difference exceeds a threshold, the functionality 139 rejects the object from localization use, i.e., prevents output of the object from object tracked detections functionality 130.

d. Object Detector and Tracker: One or more embodiments includes processing the diverse sensors independently and doing late sensor fusion 138 as illustrated in FIG. 1 for improved integrity. In addition to the sensor diversity, one or more embodiments utilize a temporal diversity principle (tracking objects over a time window) to reduce the false detections. Moreover, the one or more embodiments utilize classical detectors 134 (non-AI-based detectors) to supervise the output of the AI-based detectors 132 (e.g., neural networks) for algorithmic diversity and to reject possible false detections from the AI detectors 132. The fusion component 138 incorporates data association rules that will allow only associating objects from the diverse sensor pipelines if they have compliant object types and have sufficient overlap. In at least some embodiments, sufficient overlap is a tunable or adjustable parameter, e.g., greater than 50% overlap of detected object parameters (such as position, shape, or the like). In at least one embodiment, system 100 calculates the intersection over union (IOU) which is representing the intersection of the two bounding boxes divided by their union. The IOU already accounts for the volume of intersection in 3D and thus there is no need to calculate each dimension separately. These data association rules help with rejecting some false detections for improved integrity; for example, a camera sensor can detect a type “pedestrian,” while the LiDAR sensor may detect the object as “signal” incorrectly. Since the type is not compliant as between the two sensors, the object will be flagged and rejected. The fusion component 138 also incorporates proper “track management” which tracks the confidence level of each tracked object in terms of how consistent the apparently stationary object is detected over time. The moving objects are rejected when monitoring their motion over time. Tracked objects with low confidence level are not stored in the local map. Only very trusted objects, with sufficiently high confidence level in their detection and their motion status (i.e., stationary) are sent to local map to be used in localization for high integrity. In at least some embodiments, the confidence level is determined within fusion component 138 by tracking the confidence level for each tracked target by observing the number of successful associations with new measurements from diverse sensors are obtained for the tracked object. In some embodiments, the confidence level is determined as a counter based on the number of successful associations or as a probability based on successful and unsuccessful associations. The use of temporal trackers also allows the tracking of features of large objects that may not fit within the FOV of the sensors (e.g., platforms).

e. Supervision for verifying stationary objects: one or more embodiments provide for supervision on verifying the tracked landmark objects are stationary with respect to the ground (in the form of supervision-stationary object functionality 139) before using them in the localization of the train under consideration. In one or more embodiments, the supervision functionality 139 monitors the innovation signal of the tracker (136A and 136B) of the fused objects (difference between predicted position and measured position of object) over a time window to see if the prediction of the motion of the object based on the train motion model is consistent with the actual motion pattern of the object. The innovation signal is generated based on the difference between a predicted location of a tracked object versus the measured location of the tracked object. The predicted location is calculated based on the previous location of the tracked object and the motion model used in the filter. An innovation test determines whether the innovation signal difference exceeds a threshold and flags the tracked object. If the difference signal exceeds the threshold this indicates that the tracker predictor is inconsistent with the received measurement of the object location. Suspected objects of non-trustable motion patterns are flagged and removed for improved integrity. in at least some embodiments, non-random oscillations in the innovation signal such as a bias or a uni-sign error (either always positive or always negative) indicate an inaccuracy in the prediction of the object location, which indicates that the assumption of “stationary object” moving in the onboard sensor space according to the ego train motion model is possibly incorrect. In at least one embodiment, the supervision functionality detecting bias behavior in the innovation signal is enough to suspect the target is stationary and to reject the object. In one or more embodiments, the velocity of the tracked landmark object is determined considering the train trajectory and relative motion between the train and the object in order to perform plausibility checks against the SIL4 odometry input. Objects with non-consistent velocities with the train velocity are flagged and removed for improved integrity. In one or more embodiments, the velocity of the tracked landmark objects are provided by onboard relative speed measurement sensors such as Doppler radars, Frequency-Modulated Continuous Wave (FMCW) LiDARs, camera-based ground speed estimator or similar.

Scene-based localization system 100 also includes path extraction functionality 140.

Path extraction component 140 is similar in functionality to object tracking component 130; however, the train tracks are the detected objects in path extraction component 140. Similarly, AI-based detector 142, classical detector 144, tracker 146, and fusion 148 have similar functionality to the counterparts in object tracking component 130 though directed to the tracks. In supervision on path extraction functionality 149 (included in path extraction component 140), a location received from localization block 150 allows the supervision functionality 149 to receive a map from database 114 and the centerline of the path at the location and compare the path from the map with the extracted path received from the path extraction component 140. If the extracted path is inconsistent with the reference map loaded track centerline, the extracted path is flagged as being inconsistent and the extracted path is not provided as an output of path extraction 140. In at least one embodiment, a difference in distance between extracted tracks in centimeters is a basis for a determination of inconsistency. In another embodiment, parameters of the extracted polynomial expressing the two tracks is used as a basis for a determination of inconsistency.

f. Path extraction: the path extraction component 140 uses the diverse sensor technologies to extract the ego track path as well as neighbor tracks within the sensors FOV. The component structure follows the same safe architecture used in the Object Detector and Tracker component for high integrity. The ego track information of the train is important for contextual scene features relating the landmark objects to the ego track improving the robustness of the solution. In one or more embodiments, the ego track path is extracted in the local map from the sequence of provided sensor positions from the fusion of Object Detector and Tracker component 130 without the use of PE component 140 output. For this case, the path will be corresponding to the past traversed path by train only, but SIL4 odometry and IMU rate gyro information can be used to predict from the previously constructed train path the forward path. In one or more embodiments, after the first successful localization of the train position and orientation, the known position and orientation of the train are used to extract from the map spline information the forward path of the ego track. Then, a consistency check/supervision is performed by supervision component 149 between the extracted path using PE component and the extracted path from spline information in the stored reference map. Inconsistencies will be flagged and initiate safe reactions for high integrity.

Scene-based localization system 100 also includes a localization functionality 150. Localization functionality 150 receives objects from object tracked detections 130 and ego train path from path extraction 140. Localization functionality 150 also receives a localized map segment from map segment loader 112. Localization functionality 150 generates a position and/or orientation of the vehicle as an output. Localization functionality 150 outputs a hypothesized train position based on guideway spline and known location of landmark objects in the reference map. The hypothesis train position with minimized error vector is output by localization functionality 150.

Localization functionality 150 includes local map generation functionality 152, global matching functionality 154, localization estimator functionality 156, and safety supervision functionality 158 (supervision-RMSE vs. reference map).

g. Local map generation functionality 152: A local map stores features of tracked objects and ego track information in a unified local coordinate frame, from the current moment in time and back to a definable, adjustable moment in the past. The local map is provided by high-confidence tracked objects only. In some embodiments, the confidence is based on a counter indicating a number of times that successful associations occur or a probability of confidence. In some embodiments, a track management subcomponent of tracker 146 provides the confidence measurement. Local map generation functionality 152 converts the received locations of objects in the current sensor frame, i.e., from object tracked detections 130, to the defined unified reference frame of the local map. In one or more embodiments, the local map component 152 performs a supervision on the updates of the location of objects in the map to ensure they are consistent with the train maximum possible speed and acceleration and/or with the operational speed from SIL4 odometry and IMU rate gyro. Local map generation functionality 152 saves the information of objects tracked over time in a unified local reference frame to facilitate comparison with the reference map in the global matching functionality 154. Local map generation functionality 152 outputs a generated local map for use by global matching functionality 154.

h. Global matching functionality 154: The global matching functionality 154 compares the features of the landmark objects in the local map, including the contextual features of the relationship between the objects and the ego track, to the reference map, and uniquely identifies the ID of a constellation of landmark objects in the reference map corresponding to the detected constellation of objects. In one or more embodiments, all the features of the constellation of landmarks are combined together in a high-dimensional list or tensor, and then a data association/matching algorithm is used to calculate a matching score when comparing two constellations. The constellation in the reference map with the highest matching score will be selected. Map segment loader 112 outputs a relevant section of the reference map from map database 116. In at least some embodiments, the reference map is a certified map. Local map generation 152 generates a local map comprising the tracked objects from sensor detections from sensor functionality 120. In one or more embodiments, the safety supervision functionality 158 flags the case when more than one constellation have similar matching scores indicating ambiguity of determining the proper matching. The system then fails-safe to no localization for high integrity. In one or more embodiments, a distance/dis-similarity metric is used to compare difference between constellations in the high-dimension feature space. The matching happens if the distance/dis-similarity metric is below a defined threshold. The defined threshold varies based on the feature used for matching. In at least one embodiment for a pattern of objects feature, the tolerance threshold on mutual distances error is 10 centimeters. In one or more embodiments, geometric hashing method(s) is used to compare the relative patterns of objects in local map vs the pattern in reference map as part of calculating an overall matching score.

i. Localization estimator functionality 156: After the corresponding constellation of landmark objects in the reference map has been uniquely identified, the known locations of the landmark objects in a global coordinate system are used to localize the vehicle under consideration. In addition to the calculation of the vehicle position with high integrity, one or more embodiments reliably calculates the orientation of the train based on the known location of the sensors on the train (front vs rear) and monitored order of appearance of landmark objects (e.g., from near to far objects). In particular, one or more embodiments use the known locations of the landmark objects in the global coordinates and sensor measurements (e.g., measured ranges and possibly angle of attack (AoA) to the landmark objects) to identify position of a reference point of the vehicle under consideration in the global coordinates of the reference map. In one or more embodiments, a transformation matrix (i.e., a rotation matrix and translation vector) is defined between local and global map coordinates based on locations of corresponding landmark objects in both maps, and then the transformation matrix is used to transform the location of the reference point of the vehicle under consideration from local to global coordinate frame. In at least one embodiment, the transformation matrix is generated by transformation matrix functionality 118. In one or more embodiments, the global matching and localization estimator components are combined without loss of generality through constrained optimization. In particular, since the position of the train is restricted to tracks in the region of interest, the train localization is estimated by maximizing the matching score between the features of the landmark objects in local and reference maps. In one or more embodiments, the train localization through constrained optimization may include vehicle motion information (e.g., speed, acceleration travel direction, stationary status, and their associated uncertainties) from SIL4 odometry and stationary status. Note that this constrained optimization formulation uses the nature of the rail environment, having trains moving on known tracks, in order to reject a priori non-feasible positions for better integrity and improved computational efficiency.

j. Safety supervision functionality 158 on calculated position: Once the position of the train is determined in the global coordinate frame of the reference map, the distances between the calculated position and the known locations of the landmark objects in the reference map are calculated. Then, since the ranges to the corresponding objects in the local map are known, those ranges are compared to the calculated distances between the train position and landmark objects to generate an error vector. The safety supervision functionality 158 adds a maximum permissible root mean square error (RMSE) (e.g., 10 cm) to ensure that the position of the train is accurately calculated in the localization estimator component 156. In one or more embodiments, the velocity of the train is estimated from the calculated scene-based position output and is compared to SIL4 odometry speed, e.g., from odometer 104, for consistency. For the case of inconsistency, an alarm is raised and the system fails safe to generate no localization output. In one or more embodiments, the changes in the calculated scene-based output position are used to indicate the stationary status and/or direction of travel of the train. Then, this information is cross-checked with SIL4 stationary function output from a vehicle, based on radar and IMU or similar, or to output direction of travel from SIL4 odometry for high integrity.

Referring to the above detailed elements, one or more embodiments provide safe architecture design and supervisions. One or more embodiments provide a high-integrity localization system. One or more embodiments include detector, tracker, fusion and path extraction functionality. One or more embodiments include identifying an object based on comparing its features to reference map stored features in the rail context. One or more embodiments use interpretable features of landmark objects. One or more embodiments use temporal tracking to handle extended landmark objects beyond the FOV of sensors (e.g., platforms). One or more embodiments perform global matching and localization estimation as a constrained optimization problem in item (i), with the aid of track/spline constraints in rail application.

### Verification Method of Robust Uniqueness of Constellation of Landmarks

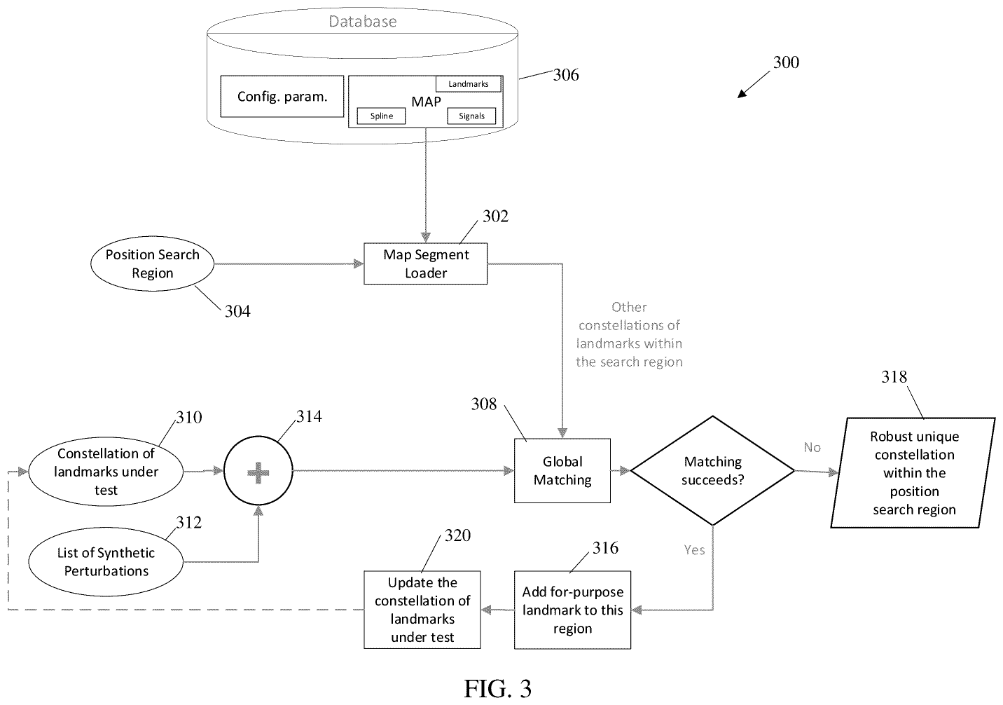

FIG. 3 is a process flow diagram of a verification method 300 for robust uniqueness of a constellation of landmarks. One or more embodiments provide a method that is conducted offline on the reference map in order to evaluate the uniqueness of a given constellation of landmark objects under consideration with respect to: (1) all other constellations of landmark objects in a defined position search region and (2) under various synthetic perturbations to verify the robustness of the uniqueness property for a given constellation. The uniqueness property of landmark constellations corresponds to not having two constellations of landmarks that may result in matching scores that are very similar when considering (1) intrinsic guideway features (i.e., landmark object pattern and their contextual information) are compared and (2) feasible perturbations emulating sensor measurement errors (i.e., false detections and/or occlusions). In at least one embodiment, a tolerance for each feature is defined and if the difference between two constellations is within the tolerance, then the two constellations are not distinguishable, i.e., the constellations are said to be very similar.

To that end, the position search region in this verification is first determined based on the type of the considered localization. Typically, and without loss of generality, the search region is selected to cover all adjacent localization regions for the warm localization problem assuming that the coarse position input in FIG. 1 will be accurate enough to restrict the search region to only adjacent localization regions to the current region (an aspect of the design). Adjacent localization regions are considered to extend the robust uniqueness by accounting for at least one localization region with no localization output due to track constructions causing misdetection or occlusion of most landmarks. Without loss of generality, the search region is extended to the entire guideway for the case of the cold localization problem. All constellations of landmarks within the search region are compared to the constellation under test. The offline verification method identifies the guideway regions that use for-purpose landmarks in order to provide features for robust uniqueness in the localization regions with similar or not sufficient guideway features.

For the considered constellation of landmark objects, a list of synthetic perturbations are performed and then a global matching algorithm is performed between the perturbed constellation and other constellations in the search region from the reference map. The typical list of perturbations includes, but is not limited to:

Errors in the locations of the objects in the constellation under test emulating possible errors in the objects of the local map in reality due to sensor measurement errors (e.g., randomness, bias, scale factor error, or the like)

Errors in features of the landmark objects in the constellation (e.g., width, height, color, type, or the like)

Misdetection of some of the objects in the constellation of landmark objects emulating possible occlusion or false negative detections of sensor pipelines

False objects added to the constellation emulating false positive detections of sensor pipelines.

This list of perturbations would result in Monte-Carlo-like synthetic tests, and for each test, successful global matching with other constellations in the search region is stored. If not successful for all the tests, i.e., if no match is found, then the constellation under test is robust under different considered perturbations, but if one or more of the tests has successful matching, then the constellation under consideration may be confused in practice, under perturbations/errors, with other constellations in the search region resulting in wrong localization. For that case, it has been determined that the constellation of landmarks in that localization region needs additional for-purpose landmarks to distinguish it from neighbor constellations in the search region. Adding for-purpose landmarks is performed incrementally and every time a for-purpose landmark object is added, the assessment of the robust uniqueness is repeated until the updated augmented constellation of landmarks is robustly unique under the considered perturbations. In at least one embodiment, two objects/constellations are considered similar if the differences between compared features are below prescribed thresholds. Then, the thresholds are set to higher values to consider all possible errors/perturbations in detection that may occur. That way, two constellations are dissimilar only if the features are very different, i.e., exceeding the thresholds. For example, a threshold is set on the difference between two patterns (mutual distances between objects) having to be >1 meter to consider the two patterns as being dissimilar. Hence, any detection error below 1 meter does not result in the two constellations being similar if they are separated by more than 1 meter as verified offline. Thus, one or more embodiments only add for-purpose landmark objects where needed, achieving a balance between having a robust high-integrity localization system against perturbations and the cost of added landmark objects.

Note that for the above verification method to be effective the certifiable map should be a true/accurate representation of all objects in the search region (all possible constellations of objects).

One or more embodiments provide a method for verification of robust uniqueness of a constellation of landmark objects.

Turning to FIG. 3, the process flow begins at map segment loader 302 (similar to map segment loader 112) where a defined position search region 304 to be evaluated is received or selected and the localization region of the reference map corresponding to the search region is obtained from a database 306, e.g., database 114. In at least some embodiments, localization regions adjacent to the search region are also obtained from the database 306. Map segment loader 302 outputs constellations of landmarks within the search region. The process flow proceeds to global matching 308.

A given constellation of landmarks being tested 310 is subjected to one or more synthetic perturbations from a list of perturbations 312 via perturbation process 314. The given constellation 310 and the set of perturbed versions of constellation 310 are provided as input to global matching 308. The set of the given and perturbed versions of constellation 310 are referred to as the constellation set under test 310.

For the constellations in the constellation set under test 310, the global matching process 308 is executed to compare the constellations to the output constellations from map segment loader 302. If a match within a predetermined match threshold is found as between at least one constellation in the constellation set under test 310 and at least one constellation from map segment loader 302, then there is no robust uniqueness of the constellation forming the basis for the constellation set under test 310 and the flow proceeds to process 316.

If a match is not found, then there is robust uniqueness of the constellation and the flow proceeds to process 318 and the constellation is added to the reference map in database 306. In at least one embodiment, the constellation determined to be robustly unique with respect to all other constellations in the position search region is distinguishable enough to be added to the reference map for estimation of position. Process flow method 300 is then executed for another position search region and constellation 310.

At process 316, at least one for-purpose landmark is added to the search region 310 and the flow proceeds to process 320. In some embodiments, more than one for-purpose landmark is added to the search region 310.

At process 320, the constellation of landmarks under test 310 is updated to include the added for-purpose landmark and the updated constellation is provided as an input to the process flow for re-evaluation of uniqueness. In some embodiments, the process flow repeats until uniqueness of the constellation 310 is obtained.

The following description sets forth advantages of one or more embodiments.
1. Dense installation of landmarks: this is addressed by using natural landmark objects (general objects in the guideway) and only adding minimal number of passive for-purpose landmarks for achieving robust uniqueness of a constellation of landmark objects when needed based on the verification methodology as described in detail above. The added landmarks are not installed on the tracks but on easily accessible off-track regions. Advantages include the reduction of cost of installation and maintenance of added landmark objects.
2. Active landmarks: this is addressed by using natural landmark objects in the guideway and only adding minimal number of passive landmark objects (e.g., passive radar reflectors) when needed. Advantages include the reduction of cost of installed landmark objects and their installation and maintenance cost.
3. Lack of integrity: one or more embodiments provide a high-integrity scene-based localization system described above based on multi-sensor diversity, algorithmic diversity, temporal diversity, use of sensor and safety supervisions, use of interpretable object and scene features, and verification of robust uniqueness of used constellation of landmark objects.
4. Lack of interpretable features for matching: One or more embodiments utilize interpretable features of the landmark objects and the contextual scene that are suitable for rail application, and that are easily understood and justified by humans, which is another important advantage over scene-based positioning methods comparing captured images to database of images.
5. Incapability of handling cases when distinct scene features are extended beyond sensor FOV: One or more embodiments address this by using temporal tracking of features of extended objects (e.g., platforms). The temporal tracking also play a important role in reducing false detections.
6. Non-robustness against scene variations and environmental conditions: One or more embodiments address this by using diverse sensor technologies and algorithms, temporal tracking, contextual scene features that are robust against detection errors and occlusions such as the use of the landmark objects associated to the ego track that are less likely to be occluded by neighbor trains or pedestrians on platforms, and verification of robustness of the uniqueness property of a constellation of landmark objects under various perturbations.
7. Lack of verification method of uniqueness of a constellation of landmarks: One or more embodiments address this by providing a method for verification of robust uniqueness of a constellation of landmarks under various perturbations as detailed above.
8. Difficulty of maintaining/updating the reference map: One or more embodiments address this by storing information of modular objects in the map rather than entire images of the scene. Thus, a minor update to one of the objects in the map would result in only one update to one object. This saves time and money by avoiding a lengthy, expensive update of full sections of the map.
9. Computational inefficiency: One or more embodiments are computationally efficient as they only compare properly selected features of finite objects and not entire image pixels. This can save the money of additional computational resources.
10. Lack of orientation information: One or more embodiments provide both the position and orientation of the vehicle.
11. Localization accuracy may not meet train to platform alignment requirements: One or more embodiments address this by first using sensor fusion of different sensor technologies which is expected to improve accuracy over individual sensor technologies, adding a supervision on RMSE of ranges to landmarks in localization estimator component (e.g., 10 cm) to reject non-accurate positions, and using passive reflectors when needed to improve accuracy. Indeed, radar and/or LiDAR range and angle of attack (AoA) measurements accuracy to a passive landmark or natural landmark in the platform is sufficient to meet the train to platform alignment requirement.

An example of an implementation of one or more embodiments is described above in connection with FIG. 1. In one or more embodiments, the architecture is designed to achieve high integrity via sensor diversity, algorithmic diversity, temporal diversity (object tracking), proper sensor and function supervisions, the use of interpretable features of landmark objects and contextual scene including ego track information, and verification of robust uniqueness of a constellation of landmark objects as illustrated in FIG. 3. In one or more embodiments, a constellation of landmark objects uses natural landmark objects whenever possible and complements them in designated areas by for-purpose landmark objects (e.g., passive radar reflectors) to satisfy robust uniqueness of a constellation of landmarks for high integrity and probably to improve localization accuracy for particular use cases (e.g., platform alignment).

Other embodiments are described below.

A method corresponding to installed for purpose landmark identification using a primary sensor.

Reference point position is estimated using the primary sensor such as a camera-based system, LiDAR and radar and checked for consistency. One sensor will be the primary while the others one will be secondary for diversity and consistency checks.

Only if the position estimates by the diverse technologies are consistent the reference point position is determined.

A method corresponding to natural landmark constellation identification by the primary sensor (LiDAR, camera, or radar sensor)

Reference point position is estimated using the primary sensors and checked for consistency with the secondary sensor(s).

Only if the position estimates by the diverse technologies are consistent the reference point position is determined.

In a sign-based variation embodiment, signs at the platform, switch or signal location contain an alphanumeric text or signature that is globally unique in the context of the railway operation. The signs location (in geographical coordinate system or in Earth-Centered Earth-Fixed (ECEF) coordinate system) is determined by guideway survey and stored in a map which also contains, in the same coordinate system, the centerline between the two ego rails. In at least one embodiment, the map also contains the dimensions of the sign.

The sign's alphanumeric text signature contains guideway direction information, i.e., facing GD₀ or GD₁ as depicted in FIG. 4. In this case, a single sign is sufficient to localize the train and the orientation can be determined when the train is stopped. The encoded information in the sign brings additional contextual information for satisfying robust uniqueness of landmark and hence having a high-integrity solution.

In at least one embodiment, a picture or pictures of each sign are also stored in the map.

When the train approaches the sign and the sign is within the camera's FOV the extracted features of the sign (e.g., color, textual entropy, textual difference, textual information) are compared to stored features of the sign. If the extracted features match the reference map stored features, then the sign is identified (i.e., its location on the map is known).

If two cameras, with a known separation distance between the cameras, are installed on the train (i.e., stereo camera) then the range from the camera to the sign and the AoA from the sign to the camera can be estimated. The estimated range and AoA accuracy depends on the camera's properties such as FOV, resolution and focal point.

The camera's position on the map, and the associated uncertainty, is determined based on the sign's location on the map and the estimated range and AoA. The position estimate based on the camera may be a coarse position estimate due to the camera's limitations such as resolution (number of pixels).

In at least one embodiment, the sign's alphanumeric text or signature are printed with a material (e.g., ink) that is reflective in the radar frequency spectrum (i.e., 76 to 81 GHz) and LiDAR frequency spectrum (i.e., 1550 nm wave length 193.4 THz, or 1064 nm wave length 281.8 THz).

In at least one embodiment, the sign's alphanumeric text or signature is made using 3D structure (e.g., “Lego” style) to utilize the LIDAR capability (i.e., high range and angular resolution) to detect 3D shapes.

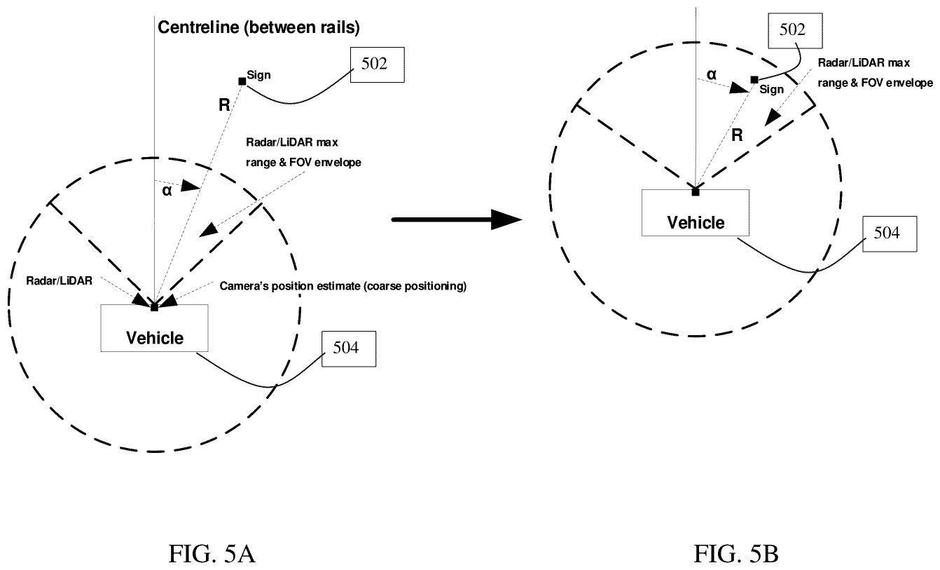

The camera's coarse position estimate is used as an envelope within which the radar and LiDAR are searching for the sign with defined reflectivity (for the radar) and defined intensity and shape (for the LiDAR) as in FIG. 5.

When the radar's maximum range and FOV envelope intersects with the sign's position on the map, the radar's position on the map (and the associated uncertainty) is determined based on the sign's location on the map and the range and AoA measured by the radar. The position estimate based on the radar is expected to be more accurate than the camera position estimate because the radar's range and angular resolutions are typically better.

In response to the LiDAR's maximum range and FOV envelope intersecting with the sign's position on the map, the LiDAR's position on the map and the associated uncertainty is determined based on the sign's location on the map and the range and AoA measured by the LiDAR. The position estimate based on the LiDAR is expected to be the most accurate because the LiDAR's range and angular resolutions are typically better than the radar and the camera. [[Question: it appears that FIG. 5 may be missing some lines or indications as to which lines represent the radar/lidar range and FOV versus the camera range and FOV. FIG. 5A is an illustration of a camera-based first position estimate (i.e. coarse position) example. FIG. 5B is a radar/LiDAR-based second position estimate with the purpose to build the integrity (using diversity) and precision. A sign 502 is ground fixed (i.e., at a fixed location). A vehicle 504 is moving on the tracks with the sensor detection envelope (range & FOV) ‘attached’ to vehicle, i.e., moving with the vehicle. In FIG. 5A, the vehicle is too far from the sign, i.e., the radar/LiDAR detection envelope does not overlap with the sign. In FIG. 5B, the vehicle moved forward and the radar/LiDAR detection envelope overlaps with the sign 502.

A common position reference point is needed to check the consistency between the camera, LIDAR, and radar position estimates. For example, as the camera is the sole sensor to identify the sign 502, the camera's reference point is selected as the position reference point. Therefore, the radar and LiDAR position estimates are converted to the camera's coordinate system.

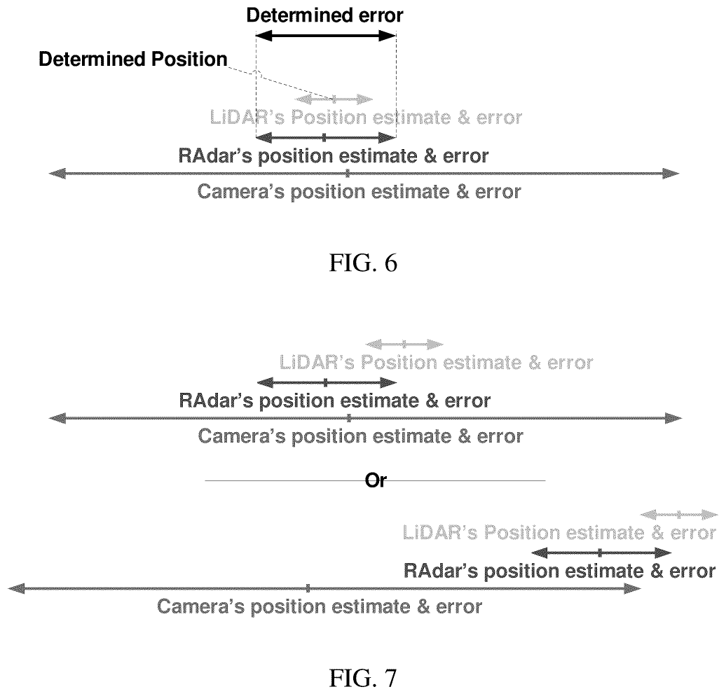

Then the camera, LIDAR and radar position estimates are checked for consistency in the camera's coordinate system. For example, if the conditions depicted in FIG. 6 are fulfilled then the position is determined to be the LiDAR's position estimate (because it is the most accurate) and the position uncertainty is determined to be the radar's position uncertainty as the LiDAR's position estimate is fully contained within the LIDAR's position estimate and the radar position estimate is the supervision to achieve the SIL4 function properties.

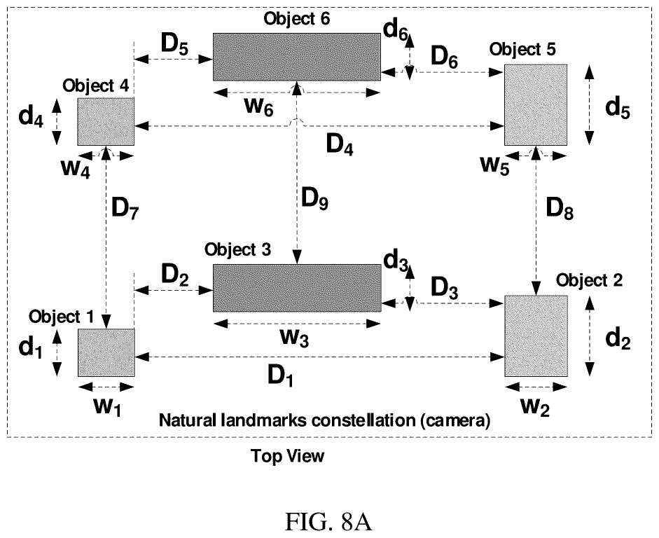

However, if the estimated positions are inconsistent, as depicted in FIG. 7, the position cannot be determined. In FIG. 7, the LiDAR position estimate is outside the position error of the radar in the first example and the LiDAR position estimate is outside both the radar and camera position errors in the second example (lower graphic).

One or more embodiments using only natural landmark objects (general objects in the guideway) are described

An embodiment based on a camera detecting a natural landmark constellation is described.

At certain locations, natural properties of the guideway and its surroundings may contain unique features that can be used to localize the reference point on the map. For example, a constellation of objects that is detectable by a camera with properties such as:

Shape and/or color of the individual objects, and/or

Relative geometry between the individual objects.

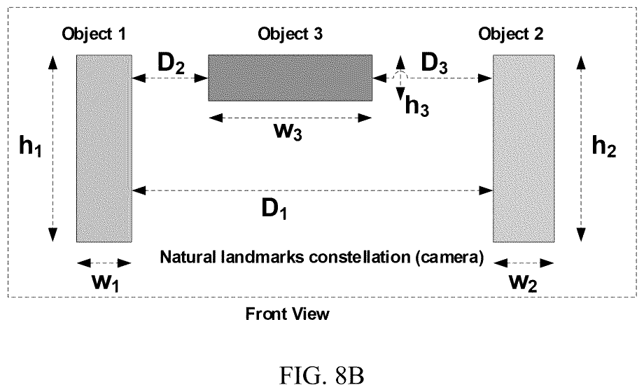

FIG. 8A is a graphical representation of a top view of a natural landmarks constellation detected using a camera. As depicted the width w1-6 of the objects is determinable as well as the depth d1-6. The distance D1-9 between the objects is also determinable. FIG. 8B is a graphical representation of a front view of the natural landmarks constellation detectable using a camera. The front view includes the height h1-3 of the objects. The objects' locations are determined by guideway survey and stored in a map which also contains the centerline between the two running rails. The map contains the dimensions of the objects, their shape and color and the relative geometry between the objects.

In at least some embodiments, a picture or pictures of each object which contain nearby objects are stored in the map.

When the train approaches the sign and the sign is within the camera's FOV the extracted features of the sign (e.g., color, textual entropy, textual difference, textual information, or the like) is compared to stored features of the sign. If the extracted features match the reference map stored features, then the sign is identified (i.e., its location on the map is known).

The range from the camera to each object in the constellation and the AoA from each object in the constellation to the camera can be estimated with a single camera because multiple objects with known size and with known relative geometry between objects is captured in a single camera frame. The estimated range and AoA accuracy depends on the camera's properties such as FOV, resolution and focal point.

The camera's position on the map, and the associated uncertainty, is determined based on each object's location on the map, and the estimated range and AoA. The position estimate based on the camera may be a coarse position estimate due to the camera's limitations such as resolution (number of pixels).

In some embodiments, a subset of natural landmarks constellation objects are “equipped” with sign or signs that are detectable by the radar and the LiDAR to achieve the SIL4 and performance (accuracy) properties of the localization function via independent diverse checking. These signs may or may not contain alphanumeric text or signature that are detectable by the camera.

The position determination by the radar and the LIDAR, and the consistency cross check functionality are the same as described at the above description regarding a sign-based variation embodiment.

An embodiment based on LiDAR detecting natural landmark constellation is described.

This method is similar to the camera detecting a natural landmark constellation above except the LiDAR is the sensor detecting natural properties of the guideway and its surroundings that may contain unique features that can be used to localize the reference point on the map. For example, a constellation of objects that is detectable by a LiDAR with properties such as:

Shape of the individual objects,

Intensity (reflectivity) of the individual objects, and

Relative geometry between the individual objects.

The objects' locations are determined by guideway survey and stored in a map which also contains the centerline between the two running rails. The map contains the dimensions of the objects, their shape and intensity and the relative geometry between the objects.

In at least some embodiments, a subset of natural landmarks constellation objects is equipped with a sign or signs that are detectable by the radar, LiDAR, and in some cases (if the sign contains alphanumeric text or signature) by the camera, to achieve the SIL4 and performance (accuracy) properties of the localization function via independent diverse checking. In some embodiments, the signs contain alphanumeric text or signature that are detectable by the camera.

The position determination by the radar and the camera, and the consistency cross check functionality are the same as described above.

An embodiment based on radar detecting natural landmark constellation is described.

This method is similar to the camera detecting natural landmark constellation and LiDAR detecting natural landmark constellation above except the radar is the sensor detecting natural properties of the guideway and its surroundings that may contain unique features that can be used to localize the reference point on the map. For example, a constellation of objects that is detectable by a radar with properties such as:

Shape of the individual objects,

Reflectivity of the individual objects,

Relative geometry between the individual objects, and

The objects are stationary (as the radar is capable to measure the Doppler speed).

The objects' locations are determined by a guideway survey and stored in a map which also contains the centerline between the two running rails. The map contains the dimensions of the objects, their shape and reflectivity and the relative geometry between the objects.

A subset of natural landmarks constellation objects will be “equipped” with sign or signs that are detectable by the LiDAR, radar, and in some cases (if the sign contains alphanumeric text or signature) by the camera too, to achieve the SIL4 and performance (accuracy) properties of the localization function via independent diverse checking. These signs may or may not contain alphanumeric text or signature that are detectable by the camera.

The position determination by the LiDAR and the camera, and the consistency cross check functionality are the same as described above.

Between landmarks the position is determined by a dead reckoning navigation function.

One or more embodiments use augmented landmark objects (natural landmark objects complemented by for-purpose landmarks when needed for achieving robust uniqueness and improved accuracy) and use multi-sensor architecture for sensor diversity for high integrity as described above.

One or more embodiments provide a high-integrity localization system for rail applications, which can replace the expensive and difficult-to-maintain localization solutions of transponder tags and UWB. The system is also extendible to any vehicle especially those with a defined route (e.g., buses moving on defined lanes). Additionally, one or more embodiments provide a systematic process for verifying robust uniqueness of a constellation of landmark objects for high integrity applications where safety is essential. Moreover, in one or more embodiments, tracking landmark objects features is used for predictive maintenance and/or map update of guideways.

One or more embodiments provide one or more of the following.

A scene-based localization system satisfying high integrity through multi-sensor diversity, algorithmic diversity, temporal diversity/tracking, proper sensor and function supervisions, and the use of interpretable matching features including contextual scene features.

A method for verifying robust uniqueness of a constellation of landmark objects, i.e., verifying it is distinguishable from all other constellations in the position search region under various possible perturbations (e.g., sensor measurement errors, potential false detections, and occlusion).

A method, based on the above, for determining optimal number and location of desired for-purpose landmarks for achieving robust uniqueness of a constellations of landmark objects for high integrity.

The use of landmarks with interpretable features in multi-sensor spectra and characteristics suitable for rail application.

A method for incorporating contextual scene, environment and/or operational features, suitable for rail application, in determining the matching score of the constellation of landmarks.

A method for handling large landmark objects beyond the FOV of the sensors (e.g., platforms, long buildings) using temporal tracking of the object features.

One or more embodiments provide a high-integrity scene-based localization system and verification method of robust uniqueness of a constellation of landmark objects.

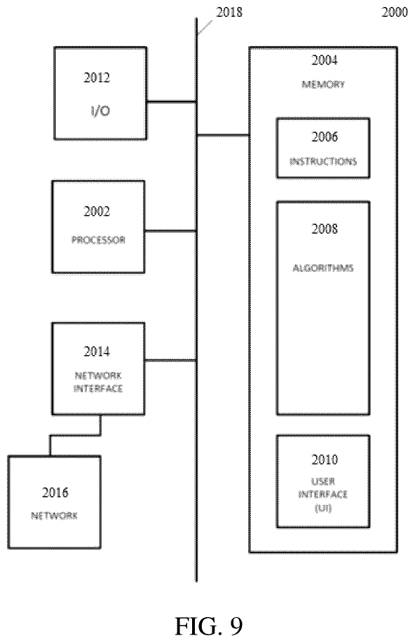

FIG. 9 is a block diagram of a processing system according to one or more embodiments.

One or more embodiments are implemented using a processing system 2000 of FIG. 9. In some embodiments, the processing system 2000 is, e.g., a general purpose computing device including a hardware processor 2002 and a non-transitory, computer-readable storage medium 2004. In some embodiments, the computer-readable storage medium 2004, amongst other things, is encoded with, i.e., stores, computer program code (or instructions) 2006, i.e., a set of executable instructions. In some embodiments, execution of computer program code 2006 by the processor 2002 implements a portion, or all, of the methods described herein accordance to one or more embodiments (hereinafter, the noted processes and/or methods).

In some embodiments, the processor 2002 is electrically coupled to the computer-readable storage medium 2004 via a bus 2018. In some embodiments, the processor 2002 is also electrically coupled to an I/O interface 2012 by the bus 2018. In some embodiments, a network interface 2014 is also electrically connected to the processor 2002 via the bus 2018. In some embodiments, the network interface 2014 is connected to a network 2016, and the processor 2002 and the computer-readable storage medium 2004 connect to external elements via the network 2016. In some embodiments, the processor 2002 is configured to execute the computer program code 2006 encoded in the computer-readable storage medium 2004 in order to cause the processing system 2000 to be usable for performing a portion or all of the noted processes and/or methods. In some embodiments, the processor 2002 is hardware, e.g., a central processing unit (CPU), a multi-processor, a distributed processing system, an application specific integrated circuit (ASIC), another suitable processing unit, or the like.

In some embodiments, the computer-readable storage medium 2004 is, e.g., an electronic, magnetic, optical, electromagnetic, infrared, and/or a semiconductor system (or apparatus or device). In some embodiments, the computer-readable storage medium 2004 includes, e.g., a semiconductor or solid-state memory, a magnetic tape, a removable computer diskette, a random-access memory (RAM), a read-only memory (ROM), a rigid magnetic disk, and/or an optical disk such as a compact disk-read only memory (CD-ROM), a rewritable compact disk (CD-R/W), and/or a digital video disc or digital versatile disc (DVD).

In some embodiments, the computer-readable storage medium 2004 stores the computer program code 2006 that is configured to cause the processing system 2000 to be usable for performing a portion or all of the noted processes and/or methods. In some embodiments, the computer-readable storage medium 2004 also stores information that facilitates performing a portion or all of the noted processes and/or methods. In some embodiments, the computer-readable storage medium 2004 stores information 2008 that includes, e.g., one or more algorithms or the like.

In some embodiments, the processing system 2000 includes an I/O interface 2012. In some embodiments, the I/O interface 2012 is coupled to external circuitry. In some embodiments, the I/O interface 2012 includes, e.g., a keyboard, keypad, mouse, trackball, trackpad, touchscreen, and/or cursor direction keys for communicating information and commands to the processor 2002.

In some embodiments, in the processing system 2000, the network interface 2014 is coupled to the processor 2002. In some embodiments, the network interface 2014 allows the processing system 2000 to communicate with the network 2016, to which one or more other computer systems may be connected. In some embodiments, the network interface 2014 implements wireless network interfaces such as BLUETOOTH, WIFI, WIMAX, GPRS, and/or WCDMA; and/or wired network interfaces such as ETHERNET, USB, and/or IEEE-1364. In some embodiments, a portion or all of noted processes and/or methods are implemented in two or more of the processing systems 2000.

In some embodiments, the processing system 2000 is configured to receive information through the I/O interface 2012. In some embodiments, the information received through the I/O interface 2012 includes, e.g., instructions, data such as scene data, set points, other parameters, or the like for processing by the processor 2002. In some embodiments, the information is transferred to the processor 2002 via the bus 2018. In some embodiments, the processing system 2000 is configured to receive information related to a user interface (UI) through the I/O interface 2012. In some embodiments, the information is stored in the computer-readable storage medium 2004 as a user interface (UI) 2010.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, one or more of the noted processes and/or methods is implemented as a software application that is a portion of a purpose-made tool. In some embodiments, a portion or all of the noted processes and/or methods is implemented as a software application that is used by the processing system 2000.

In some embodiments, the noted processes and/or methods are realized as functions of a program stored in a tangible, non-transitory computer-readable recording medium such as an external/removable and/or internal/built-in storage or memory unit, e.g., one or more of an optical disk, such as a DVD, a magnetic disk, such as a hard disk, a semiconductor memory, such as a ROM, a RAM, a memory card, or the like

One or more embodiments are implemented using hardware, code or instructions, or a combination thereof. One or more embodiments are implemented using hardware such as a processor. In some embodiments, the processor is a single dedicated processor, a single shared processor, or a plurality of dedicated and/or shared and/or parallel-processing processors. In some embodiments, the processor is, includes, or is included in a computer, a digital signal processor (DSP), a network processor, an application specific integrated circuit (ASIC), a field programmable gate array (FPGA), a combination of logic gates, hardware capable of executing software, a controller, a signal processing device, a combination thereof, or the like. In some embodiments, the processor includes or is coupled to a read only memory (ROM), a random access memory (RAM), a non volatile storage, a combination thereof, or the like. In some embodiments, other hardware is included. One or more embodiments are implemented using code or instructions to be executed by hardware, e.g., the above-described hardware. In some embodiments, the code or instructions include software, firmware, microcode, a combination thereof, or the like. In some embodiments, the code or instructions transform the hardware into a special-purpose processor for performing methods described herein. One or more embodiments is implemented in a non-transitory, tangible, machine-readable medium including executable instructions that, when executed by hardware, e.g., the above-described hardware, cause the hardware to perform methods described herein.

In some aspects, the techniques described herein relate to a localization method including: using at least two different on-board sensors to detect landmark objects of a constellation of landmark objects in a localization region of a guideway, based on distinct object features of the landmark objects; subsequently, fusing the object features detected by the at least two different on-board sensors; tracking the fused object features over time in a unified local reference frame such that a sliding window of landmark objects is maintained as a local map; and comparing the object features of the constellation of landmark objects in the local map to a reference map in order to uniquely identify a corresponding constellation of landmark objects in the reference map.

In some aspects, the techniques described herein relate to a localization method, wherein the landmark objects include a for-purpose landmark object.

In some aspects, the techniques described herein relate to a localization method, wherein the landmark objects include a platform, a building, a sign, a lamp, an electric box, or a signal.

In some aspects, the techniques described herein relate to a localization method, wherein the object features include one or more of a height, a width, a length, a size, a texture entropy, a color range, an indoor/outdoor type, a spatial distribution between objects or a texture difference.

In some aspects, the techniques described herein relate to a localization method, wherein the landmark objects include a corner location, an inscription location, a window location, and edge distance, a direction, a mesh line, or a mesh face.

In some aspects, the techniques described herein relate to a localization method, wherein the fusing includes: detecting tracked objects including: performing AI-based detecting and classical detecting based on sensor data; tracking the detected objects resulting from the classical detecting.

In some aspects, the techniques described herein relate to a localization method, wherein the detecting tracked objects is performed for each of the at least two different sensors and further including: fusing the tracked detected objects among the at least two different sensor data.

In some aspects, the techniques described herein relate to a localization method, wherein the fusing further includes supervising the detected tracked objects to reject potential moving objects.

In some aspects, the techniques described herein relate to a localization method, wherein the supervising includes monitoring a difference between a predicted object position based on a vehicle motion model and a measured position; and outputting a detected tracked object if the difference is below a threshold.

In some aspects, the techniques described herein relate to a localization method, wherein the comparing includes monitoring a distance metric based on the object feature comparison; and generating a constellation match in the reference map if the distance metric is below a defined threshold; or not generating a constellation match in the reference map if the distance metric is not below a defined threshold.

In some aspects, the techniques described herein relate to a localization method, wherein the comparing further includes: generating an error vector based on ranges to landmark objects in the local map in comparison with calculated distances to landmark objects based on sensor data.

In some aspects, the techniques described herein relate to a localization method, wherein a velocity of a vehicle having the on-board sensors is calculated based on detected tracked object data and compared with an odometry determined velocity data from the vehicle.

In some aspects, the techniques described herein relate to a localization method, further including: extracting a path of a vehicle having the at least two on-board sensors based on the sensor data.

In some aspects, the techniques described herein relate to a localization method, wherein the extracting includes: performing AI-based detecting and classical detecting based on sensor data; tracking the extracted path resulting from the classical detecting.

In some aspects, the techniques described herein relate to a localization method, wherein the extracting is performed for each of the at least two different sensors and further including: fusing the extracted paths among the at least two different sensor data, and wherein the fusing further includes supervising the extracted paths to reject extracted paths inconsistent with a reference map track centerline.

In some aspects, the techniques described herein relate to a localization method including: using at least two different on-board sensors to detect landmark objects of a constellation of landmark objects in a localization region of a guideway, based on distinct object features of the landmark objects; subsequently, fusing the object features detected by the at least two different on-board sensors; tracking the fused object features over time in a unified local reference frame such that a sliding window of landmark objects is maintained as a local map; and comparing the object features of the constellation of landmark objects in the local map to a reference map in order to uniquely identify a corresponding constellation of landmark objects in the reference map, wherein at least one landmark object of the detected landmark objects is a 3D landmark object being detectable by at least two of a camera, a LiDAR, or a radar, and wherein the 3D landmark object has alphanumeric characters or a QR code detectable by the camera to provide unique identification of the landmark object.

In some aspects, the techniques described herein relate to a method of verifying uniqueness of a constellation of landmark objects, the method including: providing a reference map to be verified, the reference map including a first constellation of landmark objects; selecting a search region that covers: all adjacent localization regions in a first case of a warm localization, or an entire guideway in a second case of a cold localization; performing at least one perturbation on the first constellation of landmark objects; performing global matching tests between the perturbed first constellation of landmark objects and all other constellations of landmark objects in the search region; determining if global matching with any of the other constellations of landmark objects in the search region is successful; determining that the first constellation of landmark objects is robust under the performed perturbations, in response to none of the global matching tests being successful; and determining that the first constellation of landmark objects is not robust under the performed perturbations, in response to one or more of the global matching tests being successful.

In some aspects, the techniques described herein relate to a method, wherein the at least one perturbation includes one or more of: emulating errors in a location of one or more landmark objects in the constellation of landmark objects; emulating errors in object features of one or more landmark objects in the constellation of landmark objects; emulating misdetection of one or more landmark objects in the constellation of landmark objects; and emulating false positive detections of one or more landmark objects in the constellation of landmark objects, and wherein the location errors are based on one or more of random sensor measurement errors, sensor bias errors, or sensor factor errors.

In some aspects, the techniques described herein relate to a method, further including: adding one or more for-purpose landmarks to the first constellation of landmark objects, in response to a determination that the first constellation of landmark objects is not robust.

In some aspects, the techniques described herein relate to a method, further including repeating the selecting, performing at least one perturbation, performing global matching tests, and determining if global matching with any of the other constellations of landmark objects in the search region is successful.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A localization method comprising:
using at least two different on-board sensors to detect landmark objects of a constellation of landmark objects in a localization region of a guideway, based on distinct object features of the landmark objects;
subsequently, fusing the object features detected by the at least two different on-board sensors;
tracking the fused object features over time in a unified local reference frame such that a sliding window of landmark objects is maintained as a local map; and
comparing the object features of the constellation of landmark objects in the local map to a reference map in order to uniquely identify a corresponding constellation of landmark objects in the reference map.

2. The localization method of claim 1, wherein the landmark objects include a for-purpose landmark object.

3. The localization method of claim 1, wherein the landmark objects comprise one or more permanent features including one or more of a tunnel mouth, a change in tunnel structure, a tunnel bifurcation, a platform, a building, a sign, a lamp, an electrical box, or a signal.

4. The localization method of claim 1, wherein the object features comprise one or more of a height, a width, a length, a size, a texture entropy, a color range, an indoor/outdoor type, a spatial distribution between objects or a texture difference.

5. The localization method of claim 1, wherein the landmark objects comprise a corner location, an inscription location, a window location, and edge distance, a direction, a mesh line, or a mesh face.

6. The localization method of claim 1, wherein the fusing comprises:
detecting tracked objects comprising:
performing AI-based detecting and classical detecting based on sensor data;
tracking the detected objects resulting from the classical detecting.

7. The localization method of claim 6, wherein the detecting tracked objects is performed for each of the at least two different sensors and further comprising:
fusing the tracked detected objects among at least two different sensor data.

8. The localization method of claim 6, wherein the fusing further comprises supervising the detected tracked objects to reject potential moving objects.

9. The localization method of claim 8, wherein the supervising comprises monitoring a difference between a predicted object position based on a vehicle motion model and a measured position; and
outputting a detected tracked object if the difference is below a threshold.

10. The localization method of claim 1, wherein the comparing comprises monitoring a distance metric based on object feature comparison; and
generating a constellation match in the reference map if the distance metric is below a defined threshold; or
not generating a constellation match in the reference map if the distance metric is not below a defined threshold.

11. The localization method of claim 10, wherein the comparing further comprises:
generating an error vector based on ranges to landmark objects in the local map in comparison with calculated distances to landmark objects based on hypothesized vehicle position on guideway spline and known landmark object locations in the reference map.

12. The localization method of claim 10, wherein a velocity of a vehicle having the on-board sensors is calculated based on detected tracked object data and compared with an odometry determined velocity data from the vehicle.

13. The localization method of claim 1, further comprising:
extracting a path of a vehicle having the at least two on-board sensors based on sensor data.

14. The localization method of claim 13, wherein the extracting comprises:
performing AI-based detecting and classical detecting based on sensor data;
tracking the extracted path resulting from the classical detecting.

15. The localization method of claim 14, wherein the extracting is performed for each of the at least two different sensors and further comprising:
fusing the extracted paths among at least two different sensor data, and wherein the fusing further comprises supervising the extracted paths to reject extracted paths inconsistent with a reference map track centerline.

16. A localization method comprising:
using at least two different on-board sensors to detect landmark objects of a constellation of landmark objects in a localization region of a guideway, based on distinct object features of the landmark objects;
subsequently, fusing the object features detected by the at least two different on-board sensors;
tracking the fused object features over time in a unified local reference frame such that a sliding window of landmark objects is maintained as a local map; and
comparing the object features of the constellation of landmark objects in the local map to a reference map in order to uniquely identify a corresponding constellation of landmark objects in the reference map,
wherein at least one landmark object of the detected landmark objects is a 3D landmark object being detectable by at least two of a camera, a LiDAR, or a radar, and wherein the 3D landmark object has alphanumeric characters or a QR code detectable by the camera to provide unique identification of the landmark object.

17. A method of verifying uniqueness of a constellation of landmark objects, the method comprising:
providing a reference map to be verified, the reference map including a first constellation of landmark objects;
selecting a search region that covers:
all adjacent localization regions in a first case of a warm localization, or
an entire guideway in a second case of a cold localization;
performing at least one perturbation on the first constellation of landmark objects;
performing global matching tests between the perturbed first constellation of landmark objects and all other constellations of landmark objects in the search region;
determining if global matching with any of the other constellations of landmark objects in the search region is successful;
determining that the first constellation of landmark objects is robust under the performed perturbations, in response to none of the global matching tests being successful; and
determining that the first constellation of landmark objects is not robust under the performed perturbations, in response to one or more of the global matching tests being successful.

18. The method of claim 17, wherein the at least one perturbation comprises one or more of:
emulating errors in a location of one or more landmark objects in the constellation of landmark objects;
emulating errors in object features of one or more landmark objects in the constellation of landmark objects;
emulating misdetection of one or more landmark objects in the constellation of landmark objects; and
emulating false positive detections of one or more landmark objects in the constellation of landmark objects, and
wherein the location errors are based on one or more of random sensor measurement errors, sensor bias errors, or scale factor errors.

19. The method of claim 17, further comprising:
adding one or more for-purpose landmarks to the first constellation of landmark objects, in response to a determination that the first constellation of landmark objects is not robust.

20. The method of claim 19, further comprising repeating the selecting, performing at least one perturbation, performing global matching tests, and determining if global matching with any of the other constellations of landmark objects in the search region is successful.
